(19) United States
(12) Patent Application Publication
(10) Pub. No.: US 2025/0288933 A1
(43) Pub. Date: Sep. 18, 2025

(54) FILTER MATERIAL WITH MEMBRANE AND FILTER ELEMENT MADE OF SUCH FILTER MATERIAL

(71) Applicant: Carl Freudenberg KG, Weinheim (DE)

(72) Inventors: Benedikt KOSS, Mannheim (DE); Tobias SCHOLZ, Viernheim (DE); Jan Thomas GOEBEL, Birkenau (DE); Madeline BREY, Weinheim (DE); Heiko SCHACHT, Weinheim (DE); Jochen HERMANN, Reichenbach-Steegen (DE); Lukas GAERTNER, Weinheim (DE)

(21) Appl. No.: 19/079,628

(22) Filed: Mar. 14, 2025

(30) Foreign Application Priority Data
Mar. 18, 2024 (EP) 24164060.6

(51) Int. Cl. B01D 46/52; B01D 39/16; B01D 46/54

(52) U.S. Cl. CPC B01D 46/521; B01D 39/1638; B01D 46/543; B01D 2275/10

(57) ABSTRACT

A filter material for air filtration in a filter element. The filter material includes a prefilter layer on an inflow side, an activated carbon layer, and a composite layer. The composite layer is formed with at least one membrane layer. The prefilter layer, the activated carbon layer and the composite layer are materially bonded to each other.

### CROSS REFERENCE TO RELATED APPLICATIONS

This application claims benefit to European Patent Application No. EP 24 164 060.6, filed on Mar. 18, 2024, which is hereby incorporated by reference herein.

### FIELD

The invention relates to a filter material for air filtration.

### BACKGROUND

Filters for the filtration of fluids, in particular air, are known from prior art. For this purpose, the filter elements are usually inserted into filter housings and air flows through them.

A wide variety of filter elements for filtering interior air are known from prior art. DE 10 2013 011 457 A1, for example, describes an interior air filter element for the driver's cabin of agricultural and work machines.

The interior air filter element comprises an adsorption filter layer with activated carbon, a fine filter layer, in particular for the separation of aerosols, and a circumferential seal to separate the raw side from the clean side when installed in a filter housing. Such a filter with multiple stages is also referred to as a multi-stage filter. By providing a pleated prefilter layer, it can be ensured that the adsorption layer and the fine filter layer are protected from excessive dust loading and that their function is maintained for as long as possible. A disadvantage of this structure is that the prefilter layer requires additional installation space, and the filter element cannot be built as compactly.

In an embodiment, the present disclosure provides a filter material for air filtration in a filter element. The filter material includes a prefilter layer on an inflow side, an activated carbon layer, and a composite layer. The composite layer is formed with at least one membrane layer. The prefilter layer, the activated carbon layer and the composite layer are materially bonded to each other.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of a filter material in a sectional view;

FIG. 2 shows an embodiment of a filter material in a sectional view;

FIG. 3 shows an embodiment of a filter material in a sectional view;

FIG. 4 shows an embodiment of a filter material in a sectional view;

FIG. 5 shows a section from a view of a filter material after pleating; and

FIG. 6 shows a filter element with a filter material in a spatial representation.

### DETAILED DESCRIPTION

An embodiment of the present disclosure provides a filter material which, compared to known filter materials, exhibits more stable filtration efficiency over the period of use, while maintaining the same installation space requirements.

According to an embodiment of the present disclosure, it has been recognized as advantageous to combine a prefilter layer, an activated carbon layer as adsorption layer and a composite layer with membrane in one filter material.

The filter material according to an embodiment is used for air filtration in a filter element. It has a prefilter layer on the inflow side, which is configured as a coarse dust filter layer, an activated carbon layer as an adsorption layer and a composite layer with membrane as a mechanical filter medium. A membrane is understood as follows: a membrane is a thin, fine-pored or fine-fibered layer. The membrane can therefore be permeable and/or semi-permeable and/or impermeable depending on the particle size. Thus, particles in the micron and sub-micron range can be filtered. The membrane can be made of polymers. Polymer-based membranes generally require additional mechanical reinforcement as they have low inherent stability. This mechanical reinforcement can be provided by the other layers of the filter material. The membrane can, for example, comprise the following polymers, alone or in combination: PTFE, PE (also LD-PE, HD-PE and UHMW-PE, PET, PVDF, PA, PLA, PU).

According to an embodiment, the composite layer has at least one membrane on a carrier layer, whereby the membrane can be provided with a cover layer on its other side. Furthermore, several membranes and carrier/cover layers can be combined with each other to form a composite layer (e.g. carrier+membrane+carrier layer+membrane+cover layer) The layers are materially bonded to each other. The carrier layer can comprise coarse fibers and the cover layer of coarse fibers and/or microfibers.

According to an embodiment, the prefilter layer, the activated carbon layer and the composite layer are materially bonded to each other. The layers are therefore not connected form-fittingly through co-pleating, i.e. not by folding the layers together, but rather are materially bonded. This material bond is also referred to as “being laminated together”.

The material bond can be achieved by any type of lamination and/or laminating by means of gluing (polymer threads, powder, M-Web, reactive or thermal adhesive such as thermoplastic hotmelt, etc.), thermal pressing (calendering with/without melt fiber content) or by means of ultrasonic welding or calendering. The material bond can be present over the entire surface or at specific points across the surface of the layers.

Advantages of the material bond compared to the co-pleated connection of the layers can be seen in the higher mechanical stability. Another advantage is a higher temperature stability: After heat storage of the filter material, a lower increase in pressure loss can be observed compared to a co-pleated filter material with an otherwise identical structure. The filter material with its materially bonded layers can also be pleated well as a whole. Without a material bond, a maximum of two layers can usually be co-pleated together. A further layer must then be pleated separately, so that a filter element comprises two layers, namely the pleated and the co-pleated layer. However, such a filter element comprising several layers then requires a larger installation space. Thanks to the material bond of all layers, a filter medium with three or more layers can be created, which requires less installation space when subsequently pleated compared to co-pleated filter media.

Thanks to the combination of the prefilter layer and the composite layer with membranes in one filter material, a high dust storage capacity with a high quality factor is achieved at the same time. In relation to its thickness, such a material exhibits good values: by using the filter material in a filter, good filtration efficiency can be achieved without increasing the pressure loss.

The advantage of using a membrane compared to thicker fibers is that this has a larger surface area and therefore enables improved filtration performance and a longer filter service life. Particularly, the high barrier effect (interception effect) due to the small fiber diameters has a positive effect. In contrast to electrostatic separation, the effect attributable to mechanical separation is largely maintained over the service life of a filter. Furthermore, filter media with membranes have a lower pressure loss, which results in a lower energy requirement for the filter element.

The filter material according to an embodiment has an adsorption layer configured as an activated carbon layer, i.e. it has a layer with a proportion of activated carbon as adsorbent. A filter element made of such filter material is referred to as a combined filter.

In an advantageous embodiment of the filter medium, the layers are bonded by gluing with a polyolefin hotmelt as a thermoplastic adhesive. This offers the following advantages:
good adhesion properties on the substrates to be glued,
a high thermal stability of >105° C.,
stability with regard to oxidative degradation processes,
high aging resistance and
inconspicuousness with regard to fogging and odor.

The layers of the composite layer can also be glued together using polyolefin hotmelt.

In an embodiment, the prefilter layer and/or the composite layer of the filter material is electrostatically charged, e.g. using corona or high-voltage technology. This can further improve the dust storage capacity.

In an embodiment variant of the filter material, the activated carbon layer is equipped with a permanently sticky adhesion network. The permanently sticky adhesion network can also be referred to as a network-like adhesion layer, which is incorporated into the activated carbon layer. For building the adhesion layer, a polyolefin hotmelt can be used, forming the adhesion network with filaments of 5 to 20 μm in diameter. The permanently sticky adhesion network advantageously allows especially for coarser dust particles to be deposited, thereby protecting subsequent layers. Another function of the adhesion network is to bind and fix the adsorber particles of the activated carbon layer.

In an embodiment of the filter material, the filter material has an additional coarse filter layer, which can also be referred to as coarse dust filter layer. The function of the coarse dust filter layer is, on the one hand, to provide a carrier structure for the activated carbon layer and/or a support structure for the composite layer and, on the other hand, to contribute to filtration. Advantages of such filter material are therefore greater stability and a higher dust storage capacity. A higher dust storage capacity helps to keep the increase in pressure loss of the filter element as low as possible over the period of use, particularly despite the presence of the high-separation nanofibers. For this purpose, the coarse dust filter layer can be arranged upstream of the composite layer as seen in the direction of flow.

In an embodiment of the filter material, the prefilter layer or the coarse filter layer, if present, form a carrier and thus a support structure for the activated carbon layer. The activated carbon layer can also be built, in particular, from activated carbon particles glued together.

Especially in the case of an activated carbon layer, which comprises a multitude of individual activated carbon particles, it is common in the prior art to apply the bulk of these particles onto a support structure and secure them by glueing. If, as claimed here, the prefilter layer or the coarse filter layer, if present, is used as a carrier, the prefilter layer or the coarse filter layer, if present, can also fulfill a filtration function, which further increases the filtration performance of the filter material.

Different variants of the filter material are provided, which differ in their structure. Thereby the structure of the composite layer is uniform—viewed in the direction of flow—as follows: carrier layer, membrane and, if necessary, further layers.

In a first variant, the filter material has a prefilter layer on the inflow side, a composite layer on the outflow side and an activated carbon layer located in between.

This results in the following sequence of layers viewed in the direction of flow:
prefilter layer
activated carbon layer
composite layer

In a second variant, the filter material has a prefilter layer on the inflow side, a coarse filter layer on the outflow side with an activated carbon layer applied onto it and a composite layer located in between, whereby in particular the prefilter layer and the composite layer are configured as a materially bonded unit, e.g. by means of thermal welding.

This results in the following sequence of layers viewed in the direction of flow:
prefilter layer
composite layer
activated carbon layer
coarse filter layer

In a third variant, the filter material has an inflow prefilter layer with an activated carbon layer applied onto it, whereby the activated carbon layer is downstream of the prefilter layer, an outflow composite layer and a coarse filter layer located in between, whereby the coarse filter layer and the composite layer in particular are configured as a materially bonded unit, and are, for example, glued together with thermoplastic hotmelt.

This results in the following sequence of layers viewed in the direction of flow:
prefilter layer
activated carbon layer
coarse filter layer
composite layer

In a fourth variant, there is a prefilter layer on the inflow side, a coarse filter layer with an activated carbon layer applied onto it on the upstream side, a further coarse filter layer and a composite layer on the outflow side. In particular, the further coarse filter layer and the composite layer are configured as a materially bonded unit, e.g. by means of thermal welding.

This results in the following sequence of layers viewed in the direction of flow:
prefilter layer
activated carbon layer
coarse filter layer
coarse filter layer
composite layer

In the second, third and fourth variants, a unit bonded by material bonding means that the prefilter layer and composite layer and/or the coarse filter layer and composite layer are already materially bonded to each other by a previous process before the material bond with the other layers takes place in a further process step. The material bond of the prefilter layer and/or the coarse filter layer and the composite layer can be achieved through full-surface thermal bonding and/or point-wise layer welding.

This can result in a particularly high strength and good processability of the filter material.

In an embodiment of the filter material, it has a progressive structure such that the porosity of the layers such as the prefilter layer, activated carbon layer and composite layer gradually decreases from one layer to the next of the filter material from an inflow side (raw gas side) to an outflow side (clean gas side). Porosity is understood here as the ratio of the void volume to the total volume of a respective nonwoven layer. Or in other words: progressive structure means that the layers—viewed in the direction of flow—become increasingly finer. This type of filter material offers particularly good dust filtration and a stable pressure difference of the filter material over time.

An embodiment also relates to a filter element with a pleated filter material as described above.

In an embodiment of the filter element, edge bands or frame elements can be attached to the pleated filter material, which provide stabilization of the filter element and can serve as sealing elements for a filter housing accommodating the filter element.

An embodiment also relates to the use of a filter element as described above as an interior air filter for filtration and purification of the cabin supply air in a vehicle, particularly in a passenger car, a commercial vehicle, or a bus.

The present disclosure described and the advantageous further embodiments of the present disclosure described also represent advantageous further embodiments of the present disclosure in combination with one another, insofar as this is technically expedient.

With regard to further advantages and constructively and functionally advantageous embodiments of the present disclosure, reference is made to the subclaims and the description of embodiments with reference to the accompanying figures.

The present disclosure will be explained in more detail with reference to the accompanying figures. Corresponding elements and components in the figures are denoted by the same reference numerals. For the sake of better clarity of the figures, a true-scale representation has been omitted.

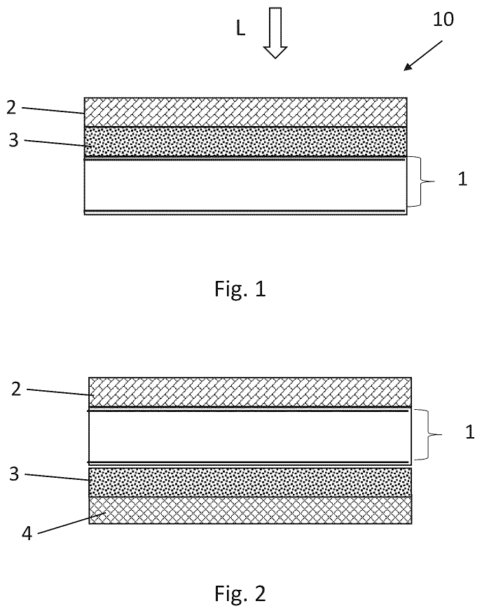

FIG. 1 shows a sectional view of a first embodiment variant of the filter material 10. The direction of flow of the air stream is shown with an arrow L. The filter material 10 has an inflow prefilter layer 2, a middle activated carbon layer 3 and an outflow composite layer 1, which is configured as a fine filter layer with one or more membranes. The composite layer 1 has a plurality of layers, namely at least one carrier layer and one membrane, whereby the layers are materially bonded to each other. However, the composite layer can also comprise several carrier, membrane and cover layers. The cover layer and carrier layer are only indicated in the illustration. Concrete embodiments of the composite layer include:
1. carrier layer+membrane
2. carrier layer+membrane+cover layer
3. carrier layer+membrane+carrier layer+membrane
4. carrier layer+membrane+carrier layer+membrane+cover layer

If several membranes and/or several carriers are used, these can differ in their properties. Thus, for example, the membranes can have different filter efficiencies.

This structure of the composite layer 1 is also present in the other embodiment variants described below. Prefilter layer 2, activated carbon layer 3 and composite layer 1 are materially bonded to each other with thermoplastic hotmelt. The cover layer, membrane, and carrier layer of the composite layer 1 can also be bonded to each other with thermoplastic hotmelt or by thermal welding.

FIG. 2 shows a second embodiment variant of the filter material 10 in a sectional view. Provided is a prefilter layer 2 on the inflow side, a coarse filter layer 4 on the outflow side with an activated carbon layer 3 applied to it on the upstream side and a composite layer 1 in between.

Prefilter layer 2 and composite layer 1 are bonded to each other by thermal welding. Composite layer 1, activated carbon layer 3 and coarse filter layer 4 are materially bonded to each other using thermoplastic hotmelt.

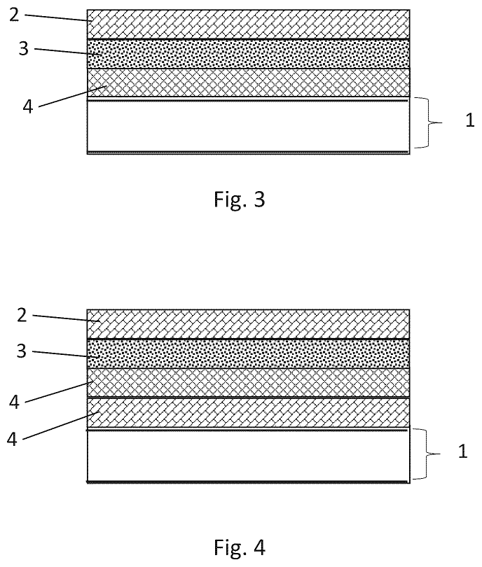

FIG. 3 shows a third embodiment variant of the filter material 10 in a sectional view. A prefilter layer 2 on the inflow side, a composite layer 1 on the outflow side and a coarse filter layer 4 located in between them with an activated carbon layer 3 applied onto it are used here, whereby the activated carbon layer 3 is arranged upstream of the coarse filter layer 4.

Coarse filter layer 4 and composite layer 1 are materially bonded to each other with thermoplastic hotmelt. Prefilter layer 2, activated carbon layer 3 and coarse filter layer 4 are bonded to each other using thermoplastic hotmelt.

FIG. 4 shows a fourth embodiment variant of the filter material 10 in a sectional view. In contrast to the variant according to FIG. 3, a further filter layer is used, namely a coarse filter layer 4, which is positioned upstream of the composite layer 1.

Coarse filter layer 4 and composite layer 1 are joined together by thermal welding. Prefilter layer 2, activated carbon layer 3 and both coarse filter layers 4 are materially bonded to each other with thermoplastic hotmelt.

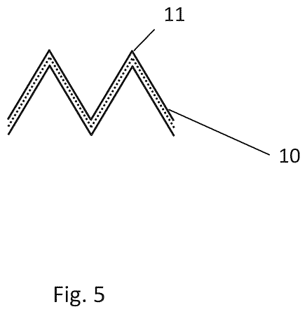

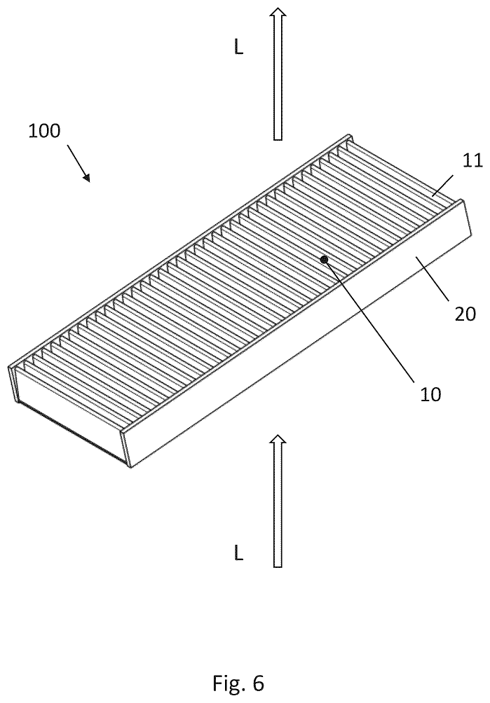

FIG. 5 shows a section of a view of the filter material 10—regardless of its structure of multiple layers—after pleating. A pleated edge is marked with 11 as an example.

FIG. 6 shows a filter element 100 with the filter material 10 in a spatial representation. The filter element 100 with the filter material 10, which can be configured as shown in FIGS. 1 to 4 and was pleated as shown in FIG. 5, has edge bands 20 attached to the pleated filter material 10, which can contribute to stabilization of the filter element 100 and can provide sealing with respect to a filter receptacle.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 composite layer with membrane
2 prefilter layer
3 activated carbon layer
4 coarse filter layer
10 filter material
11 folding edge
20 edge band
100 filter element
L air flow direction of air stream

1. A filter material for air filtration in a filter element, comprising:
a prefilter layer on an inflow side;
an activated carbon layer; and
a composite layer, which is formed with at least one membrane layer,
wherein the prefilter layer, the activated carbon layer and the composite layer are materially bonded to each other.

2. The filter material according to claim 1, wherein
the prefilter layer and/or the composite layer are electrostatically charged.

3. The filter material according to claim 1, wherein
the activated carbon layer is provided with a permanently sticky adhesion network.

4. The filter material according to claim 1, wherein
the filter material has an additional coarse filter layer.

5. The filter material according to claim 4, wherein
the prefilter layer or the coarse filter layer form a carrier for the activated carbon layer.

6. The filter material according to claim 1, wherein
the activated carbon layer comprises activated carbon particles glued to each other.

7. The filter material according to claim 1, wherein
the filter material has the following structure:
a prefilter layer on the inflow side, a composite layer on an outflow side and an activated carbon layer located in between.

8. The filter material according to claim 1, wherein
the filter material has the following structure:
the prefilter layer on the inflow side, a coarse filter layer an outflow side with the activated carbon layer applied thereon and the composite layer located in between, wherein the prefilter layer and the composite layer are configured as a materially bonded unit.

9. The filter material according to claim 1, wherein the filter material has the following structure:
the prefilter layer on the inflow side, the composite layer on an outflow side and at least one coarse filter layer located in between, wherein the activated carbon layer is applied upstream on a first coarse filter layer of the at least one coarse filter layers.

10. The filter material according to claim 1, wherein
a plurality of the composite layer, the activated carbon layer, and the prefilter layer of the filter material have a progressive structure.

11. A filter element with the filter material according to claim 1, wherein the filter material is pleated and wherein edge bands or frame elements are attached to the pleated filter material.
